(19) United States
(12) Patent Application Publication
(10) Pub. No.: US 2018/0295317 A1
(43) Pub. Date: Oct. 11, 2018

(54) Intelligent Dynamic Ambient Scene Construction

(71) Applicant: Motorola Mobility LLC, Chicago, IL (US)

(72) Inventors: Vivek Tyagi, Chicago, IL (US); Sudhir Vissa, Bensenville, IL (US)

(73) Assignee: Motorola Mobility LLC, Chicago, IL (US)

(21) Appl. No.: 15/484,863

(22) Filed: Apr. 11, 2017

(51) Int. Cl. H04N 5/92; H04N 9/87; G11B 27/34; H04N 21/442; H04N 21/41; H05B 37/02

(52) U.S. Cl. CPC H04N 5/9201; H04N 9/8715; G11B 27/34; H05B 37/0227; H04N 21/4131; H05B 37/029; H04N 21/44218

(57) ABSTRACT

Systems and methods for controlling ambient lighting at a playback location during media playback entail generating an ambient light map for controlling ambient lighting in synchrony with the media during playback of the media. The ambient light map includes lighting directions as well as a time stamp or other facility for synchronizing execution of the lighting directions with the playback of the media. For intensity-only lighting, a grayscale ambient light map may be used. Other sensory inputs may also be controlled, such as scent, temperature and tactile input. Moreover, the user mood may be detected and may then be used to modify the ambient light map.

### TECHNICAL FIELD

The present disclosure is related generally to media viewing and entertainment systems and, more particularly, to a system and method for dynamically altering a user environment in response to viewed or played audio or visual media.

### BACKGROUND

Media creators and distributors have long sought to create a more immersive environment for viewers. By increasing the immersive element of the entertainment experience, creators and distributors hope to engage users more fully, generating a larger following and more views or sales as the case may be. However, truly immersive media is typically only found in preplanned form, e.g., at amusement parks and the like. For example, some amusement parks may offer so-called 4D shows, wherein the user not only sees and hears audio-visual media such as a movie being played but also experiences stimulation of one or more other senses, e.g., smell, touch, and so on.

However, such experiences are static in the sense that they remain the same with each viewing; the movie or clip remains the same each time, as do the other environmental cues, such as a breeze or the smell of the sea. While this allows for elaborate pre-planned environmental cues, it does not allow for a dynamic reaction to previously unknown content, such as may be encountered in viewing a previously non-4D movie for the first time.

While there may be systems that provide an environmental reaction to media, these tend to be generic and nonconfigurable by the media stream. For example, systems that generate light pulses based on rhythms in music media are interesting but are not able to be configured by the media to respond in a more complex and immersive manner. Similarly, systems that control one or more colored lights based on a screen average are locked into that type of response regardless of whether it is truly appropriate in a given situation. For example, when the visual media shows outer space punctuated by a bright body such as the moon, a screen averaging system would provide a grey ambient illumination in the room rather than the more appropriate darkness of space.

Before proceeding, it should be appreciated that the present disclosure is directed to a system that may address some of the shortcomings listed or implicit in this Background section. However, any such benefit is not a limitation on the scope of the disclosed principles, or of the attached claims, except to the extent expressly noted in the claims.

Additionally, the discussion of technology in this Background section is reflective of the inventors' own observations, considerations, and thoughts, and is in no way intended to accurately catalog or comprehensively summarize any prior art reference or practice. As such, the inventors expressly disclaim this section as admitted or assumed prior art. Moreover, the identification herein of one or more desirable courses of action reflects the inventors' own observations and ideas, and should not be assumed to indicate an art-recognized desirability.

### SUMMARY

In an embodiment of the disclosed principles, a method of transferring media content is provided. The media content includes both an audio portion and a video portion, which may be encoded. An ambient light map is generated for controlling ambient lighting in synchrony with the media during playback of the media, and the encoded audio portion, the encoded video portion and the ambient light map are packaged together in a transferrable package.

In another embodiment of the disclosed principles, a method of playing media content at a playback location is provided. The method in accordance with this embodiment entails receiving a media content package containing an audio portion, a video portion and an ambient light map portion. The ambient light map portion is time-synchronized with the audio portion and the video portion. The audio portion and the video portion of the media content package are decoded, and lighting instructions are generated based on the ambient light map. The decoded audio and video portions are then played back the while the lighting instructions are transmitted to one or more ambient light fixtures at the playback location, thus controlling ambient lighting in synchrony with the played back audio and video.

In keeping with yet another embodiment of the disclosed principles, a method of controlling ambient lighting in a playback location is provided including first receiving media data and an ambient light map. The ambient light map specifies a desired ambient lighting to be correlated with the received media data. It is determined that one or more controllable ambient lighting fixtures is present in the playback location and that the one or more present controllable ambient lighting fixtures are controllable with respect to one of intensity alone and intensity and color. The ambient light map is modified by converting any colored values into grayscale values if it is determined that the one or more present controllable ambient lighting fixtures are controllable with respect to intensity alone, and lighting instructions are generated based on the ambient light map. The generated lighting instructions are then transmitted to the one or more present controllable ambient lighting fixtures.

Other features and aspects of the disclosed principles will be apparent from the detailed description taken in conjunction with the included figures, of which:

### BRIEF DESCRIPTION OF THE SEVERAL VIEWS OF THE DRAWINGS

While the appended claims set forth the features of the present techniques with particularity, these techniques, together with their objects and advantages, may be best understood from the following detailed description taken in conjunction with the accompanying drawings of which:

FIG. 1 is a modular view of an example electronic device usable in implementation of one or more embodiments of the disclosed principles;

FIG. 2 is a process view of an example implementation architecture in which a standalone display device cooperates with a portable device to configure ambient lighting while multimedia content is played on the standalone display device;

FIG. 3 is a schematic representation of data compression and transmission in accordance with an embodiment of the disclosed principles;

FIG. 4 is a process flow for creating an ambient light map and for converting from a colored ambient light map to a grayscale ambient light map in accordance with an embodiment of the disclosed principles; and

FIG. 5 is a process flow corresponding to steps taken upon receipt of media data including embedded ambient light maps in accordance with an embodiment of the disclosed principles.

### DETAILED DESCRIPTION

Before presenting a detailed discussion of embodiments of the disclosed principles, an overview of certain embodiments is given to aid the reader in understanding the later discussion. As noted above, there is a need for an ambient lighting system that responds to media in a dynamically configurable manner. In an embodiment of the disclosed principles, a media stream includes ambient lighting cues that are decodable by the media system to selectively control one or more lights in the viewing environment, e.g., the user's living room.

Thus, for example the color and intensity of ambient lighting can be controlled to match the mood or appearance of the on-screen entertainment. Similarly, environmental aspects other than or in addition to lighting may also be controlled. For example, room temperature, air movement, vibration and so on may also be controlled. In an embodiment, an ambient light map of <Aggregated color, Time> form may be created for each scene or occurrence in audio-visual material.

In an embodiment, the audio-visual data stream includes an environment field containing environmental instructions. This field may be a subpart of an existing metadata field or may be a separate field. For example, an ambient lighting map may be encoded and synchronized with the MP4 video codec format or may instead be provided separately.

Instructions are generally set to be appropriate to the media being played. For example lava bulb colors may be set when a grenade explodes in a war game or movie. In addition to environmental instructions embedded in the media data stream, uninstructed environmental reactions may occur based on other data captured during playback. For example, user emotion may be gathered via a camera and used to establish or moderate mood-based environmental effects. For example, if the embedded environmental instructions call for dark lighting but the user emotion is detected to be sad, the system may moderate the environmental instructions by providing brighter than instructed lighting.

As noted above, user emotion may be determined via interpretation of user facial image data as well as via interpretation of viewing angle data, gesture data and body language data gathered periodically or constantly by a camera associated with the system. Further, data from across a pool of many different users may be collected and aggregated to better interpret user emotion and also to preemptively predict user emotion during specific scenes. In this way, aggregate data can be used for predicting user mood while real-time user data may be used to dynamically refine the predicted mood of a specific viewer.

In a further embodiment, in addition to acquiring and interpreting mood data from a single viewer watching the screen, the system may acquire and interpret mood data from multiple users that are present in front of the camera in current scene. Based on this information, the system may then determine a strongest or most relevant mood on which to base sensory cues, or may determine a general emotion level among these viewers.

Multiple maps may be provided to accommodate different potential lighting environments at the user location. For example, if colored bulbs or LEDs are present in the user location, then colors from an ambient light map are used during decoding, whereas if the user's bulbs or LEDs are white (warm or cold) then a grayscale light map may be used while decoding the video. The grayscale light map may specify lighting in the form of <Grays, Time> or may be created from the ambient light map by pulling the intensity of the RGB colors. (E.g. Most noted image editors convert color images to black and white<Grayscales>, standard mixed of the RGB channels for their grayscale conversion: RED=30%, GREEN=59% and BLUE=11%)

In a further embodiment, the location of the user relative to the lighting and display may be used to moderate the instructed lighting or the display. For example, the perception of light changes with distance from light source. When the user's relative location is known, the system can detect which light is near to the user and appropriately adjust the intensity to provide balanced lighting

Emotion and scene context-based color adjustment may be used in an embodiment. For example, when showing a close up of a face, the dominant color of the scene may not change, but the change in emotion would be reflected in a change the ambient lights.

Moreover, complimentary color choices may be used to enhance visual effects. Thus, for example, when showing an approach to the moon, the screen color may change to white/gray being dominant, but for immersive effect, the lights may be dimmed or turned off.

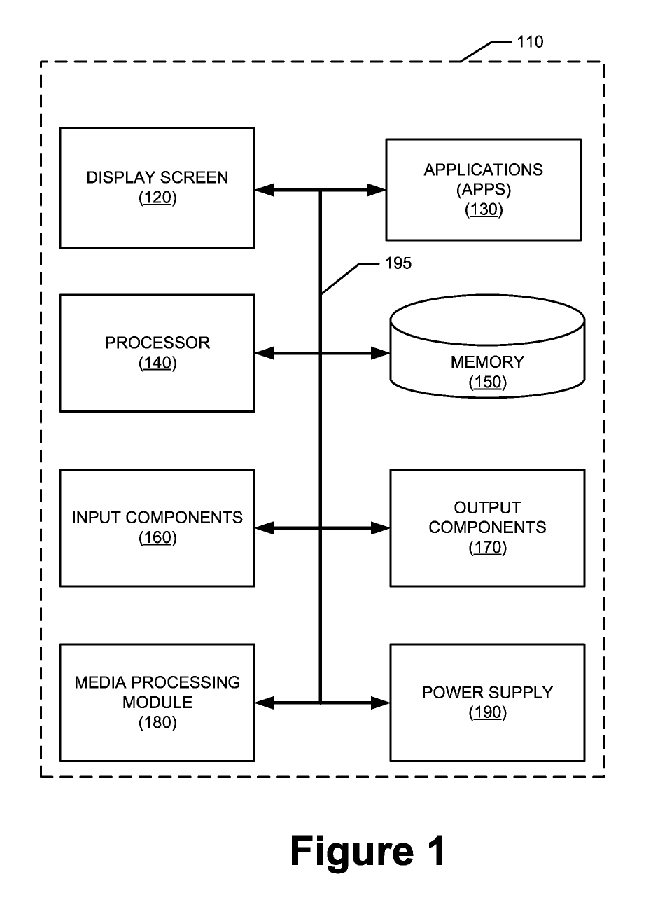

With this overview in mind, and turning now to a more detailed discussion in conjunction with the attached figures, the techniques of the present disclosure are illustrated as being implemented in a suitable computing environment. The following generalized device description is based on embodiments and examples within which the disclosed principles may be implemented, and should not be taken as limiting the claims with regard to alternative embodiments that are not explicitly described herein. Thus, for example, while FIG. 1 illustrates an example computing device with respect to which embodiments of the disclosed principles may be implemented, it will be appreciated that other device types may be used, including but not limited to laptop computers, tablet computers, embedded automobile computing systems and so on.

The schematic diagram of FIG. 1 shows an exemplary device 110 forming part of an environment within which aspects of the present disclosure may be implemented. In particular, the schematic diagram illustrates a user device 110 including exemplary components. It will be appreciated that additional or alternative components may be used in a given implementation depending upon user preference, component availability, price point and other considerations.

In the illustrated embodiment, the components of the user device 110 include a display screen 120, applications (e.g., programs) 130, a processor 140, a memory 150, one or more input components 160 such as RF input facilities or wired input facilities, including, for example one or more antennas and associated circuitry. The input components 160 also include, in an embodiment of the described principles, a sensor group which aids in detecting user location or alternatively, an input for receiving wireless signals from one or more remote sensors.

Another input component 160 included in a further embodiment of the described principles is a camera facing the user while the device screen is also facing the user. This camera may assist with presence detection, but is also employed in an embodiment to gather user image data for user emotion detection. In this way, as described in greater detail later below, a media experience may be dynamically tailored to conform to or to improve user emotional state.

The device 110 as illustrated also includes one or more output components 170 such as RF or wired output facilities. It will be appreciated that a single physical input may serve for both transmission and receipt.

The processor 140 can be any of a microprocessor, microcomputer, application-specific integrated circuit, or the like. For example, the processor 140 can be implemented by one or more microprocessors or controllers from any desired family or manufacturer. Similarly, the memory 150 may reside on the same integrated circuit as the processor 140. Additionally or alternatively, the memory 150 may be accessed via a network, e.g., via cloud-based storage. The memory 150 may include a random access memory (i.e., Synchronous Dynamic Random Access Memory (SDRAM), Dynamic Random Access Memory (DRAM), RAMBUS Dynamic Random Access Memory (RDRM) or any other type of random access memory device or system). Additionally or alternatively, the memory 150 may include a read only memory (i.e., a hard drive, flash memory or any other desired type of memory device).

The information that is stored by the memory 150 can include program code associated with one or more operating systems or applications as well as informational data, e.g., program parameters, process data, etc. The operating system and applications are typically implemented via executable instructions stored in a non-transitory computer readable medium (e.g., memory 150) to control basic functions of the electronic device 110. Such functions may include, for example, interaction among various internal components and storage and retrieval of applications and data to and from the memory 150.

Further with respect to the applications, these typically utilize the operating system to provide more specific functionality, such as file system service and handling of protected and unprotected data stored in the memory 150. Although many applications may provide standard or required functionality of the user device 110, in other cases applications provide optional or specialized functionality, and may be supplied by third party vendors or the device manufacturer.

With respect to informational data, e.g., program parameters and process data, this non-executable information can be referenced, manipulated, or written by the operating system or an application. Such informational data can include, for example, data that are preprogrammed into the device during manufacture, data that are created by the device or added by the user, or any of a variety of types of information that are uploaded to, downloaded from, or otherwise accessed at servers or other devices with which the device is in communication during its ongoing operation.

The device 110 also includes a media processing module 180 to control the receiving and decoding of multimedia signals for example, and to process the results. In an embodiment, a power supply 190, such as a battery or fuel cell, is included for providing power to the device 110 and its components. Additionally or alternatively, the device 110 may be externally powered, e.g., by a vehicle battery or other power source. In the illustrated example, all or some of the internal components communicate with one another by way of one or more shared or dedicated internal communication links 195, such as an internal bus.

In an embodiment, the device 110 is programmed such that the processor 140 and memory 150 interact with the other components of the device 110 to perform a variety of functions. The processor 140 may include or implement various modules (e.g., the media processing module 180) and execute programs for initiating different activities such as launching an application, transferring data and toggling through various graphical user interface objects (e.g., toggling through various display icons that are linked to executable applications). As noted above, the device 110 may include one or more display screens 120. These may include one or both of an integrated display and an external display.

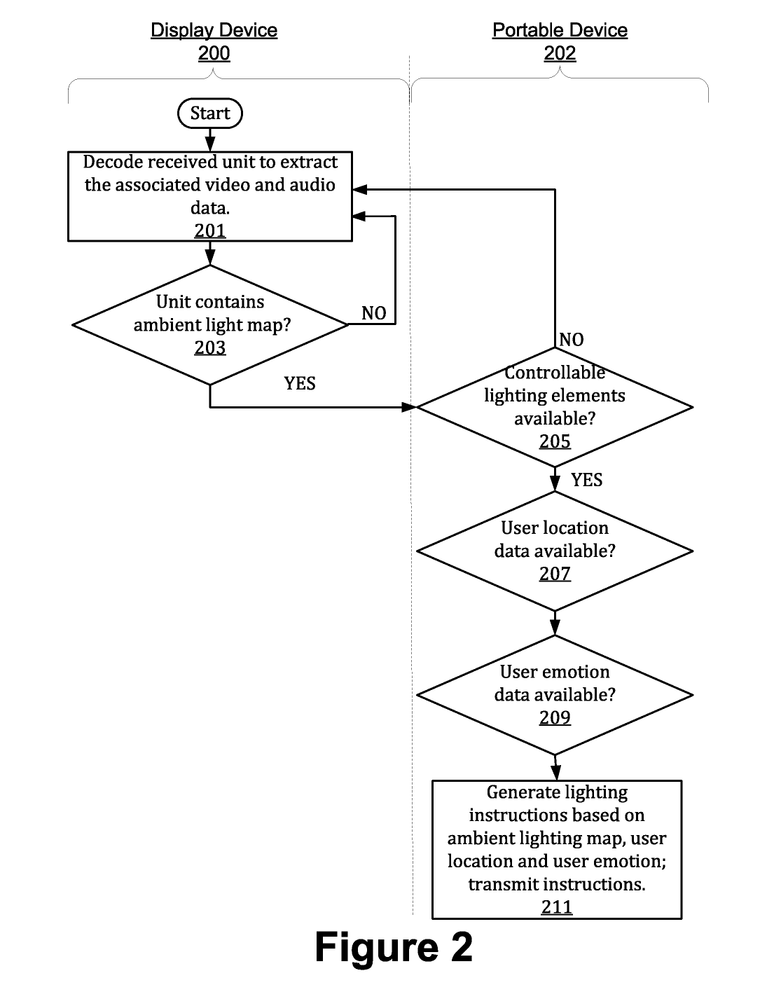

Turning to FIG. 2, this figure shows an example implementation architecture and scenario in which a standalone display device 200 cooperates with a portable device 202 to configure ambient lighting as multimedia content is played on the standalone display device 200. It will be appreciated that this architecture is but one example, and therefore alternatives are anticipated. For example, the display device 200 may itself embody the capabilities of the portable device 202. For example, a tablet, smart phone or TV might itself constitute both the display device 200 and an IOT (Internet of Things) smart home hub, capable of controlling lighting and other sensory devices.

Continuing with the example of FIG. 2, upon receipt of a unit of media content, e.g., a frame, packet or other unit, the standalone display device 200 decodes the received unit at stage 201 to extract the associated video and audio data to be played. Essentially simultaneously, the standalone display device 200 also determines at stage 203 whether the unit contains an ambient light map, and if so, the standalone display device 200 transfers the ambient light map to the portable device 202.

After an ambient light map is transferred to the portable device 202, the portable device determines at stage 205 whether there are controllable lighting elements available. Controllable lighting elements may be IoT (Internet of things) controllable bulbs, LEDs or panels for example. If the portable device 202 determines that there are no controllable lighting elements available, the portable device 202 does nothing and awaits further instructions.

Otherwise, the portable device 202 moves on to stage 207 and determines whether user location data is available and obtains any available user location data. Similarly, at stage 209, the portable device 202 determines whether user emotion data is available and collects any available user emotion data.

Finally at stage 211, the portable device 202 generates lighting instructions for the controllable lighting elements based on the ambient lighting map, the user location data if any, and the user emotion data if any. The portable device 202 may then transmit the lighting instructions to the controllable lighting elements to implement dynamic ambient lighting.

While the foregoing discussion focuses on ambient lighting, it will be appreciated that the same steps may be adapted to receiving another environment factor map, such as a scent or temperature map, and modifying that map as appropriate based on user location or emotion before implementing.

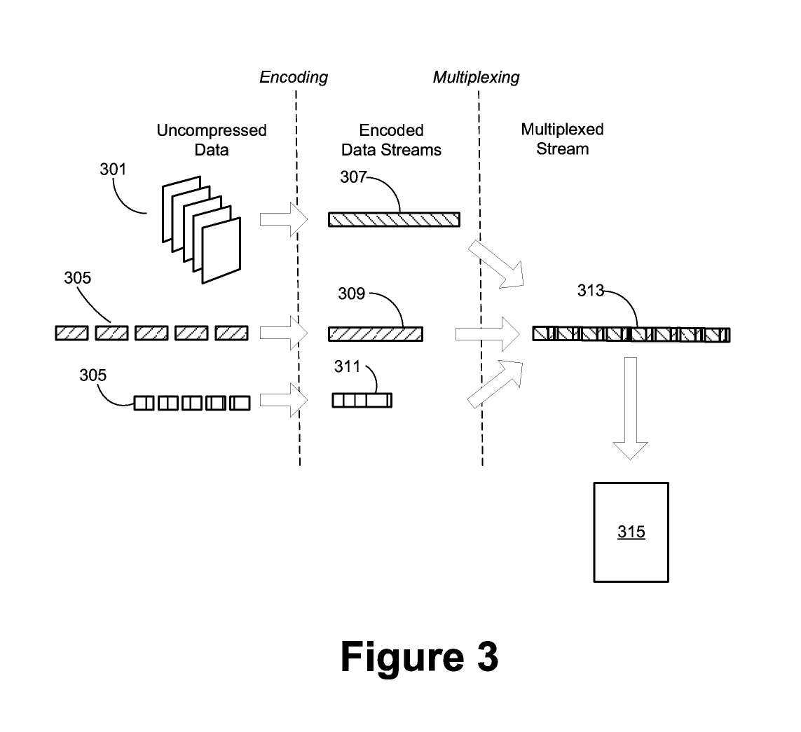

Turning to FIG. 3, this figure provides a schematic representation of data compression and transmission in accordance with an embodiment of the disclosed principles. Prior to compression or encoding, video data (frames 301) and audio packet data (packets 303) are gathered. In addition, ambient light map packets 305 are generated based on the criterion discussed above, e.g., media appearance and mood.

Upon encoding, the video data 301, audio data 303 and ambient light map packets 305 are compressed to conserve storage and transmission bandwidth, yielding compressed video data 307, compressed audio data 309 and compressed ambient light map data 311. These are then multiplexed into a packet structure to form data packet 313. The final data packet may be transmitted in real time upon completion or stored in a media file 315 for later playback.

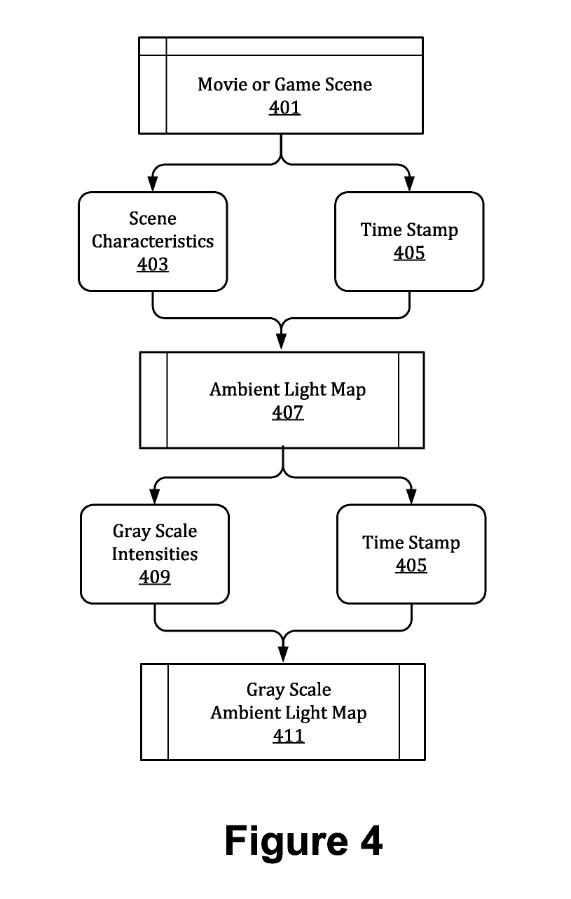

As noted above, in environments wherein controllable colored lighting is not available, a grayscale ambient lighting map may be provided or may be derived from an RGB (Red, Green, Blue) or other colored ambient lighting map. FIG. 4 shows a process flow for creating an ambient light map and for converting from a colored ambient light map to a grayscale ambient light map.

Initially, a movie or game scene 401 is analyzed to generate scene characteristics 403 and a time stamp 405 associating the resultant characteristics 403 to the scene 401. The time stamp synchronizes values in the ambient light map to points of time in the media during playback. The characteristics 403 are then used to generate an ambient light map 407. For example, the characteristics 403 may include aggregate color or scene mood, and the ambient light map 407 may then be constructed to be consistent with or related to the relevant characteristics.

The generated ambient light map 407 may be suitable for an environment having controllable colored lighting but may not be suitable for an environment having only fixed color controllable lighting, such as ordinary fixed-color incandescent, fluorescent or LED lighting. In this case, the ambient light map 407 may be processed to re-extract the time stamp 405 and to isolate the grayscale intensities 409 from the values in the ambient light map 407.

For example, if the ambient light map 407 includes RGB values, the associated intensity values may be generated using weighted multipliers of the RGB values, for example:

I_{G}=0.3×(R_{I})+0.59×(G_{I})+0.11×(B_{I}),

where I_{G}=Grayscale Intensity, R_{I}=Red intensity, G_{I}=Green intensity and B_{I}=Blue intensity. The time stamp 405 and grayscale intensities 409 are then combined to yield a grayscale ambient light map 411.

Thus, for example, if the ambient light map specified particular color intensities as a triplet R,G,B for a colored lighting fixture, the grayscale ambient light map would specify an equivalent intensity for a fixed-color lighting fixture. Under the weighting example given above, the specified intensity for the fixed-color lighting fixture would be a weighted combination of the triplet intensities, with blue intensities having much less effect on grayscale intensity than red intensities, and the effect of green intensities falling between the two. Of course, it will be appreciated that other algorithms or scaling values may be used to convert from color values to grayscale values.

While FIG. 3 shows the generation and transmission of a single ambient light map 311, which may be converted to a grayscale ambient light map if needed, it is also anticipated that in an embodiment of the disclosed principles, two ambient light maps may be included with the stored or transmitted media data. In this case, the receiving entity such as the portable device may choose which map is suitable for a given hardware environment.

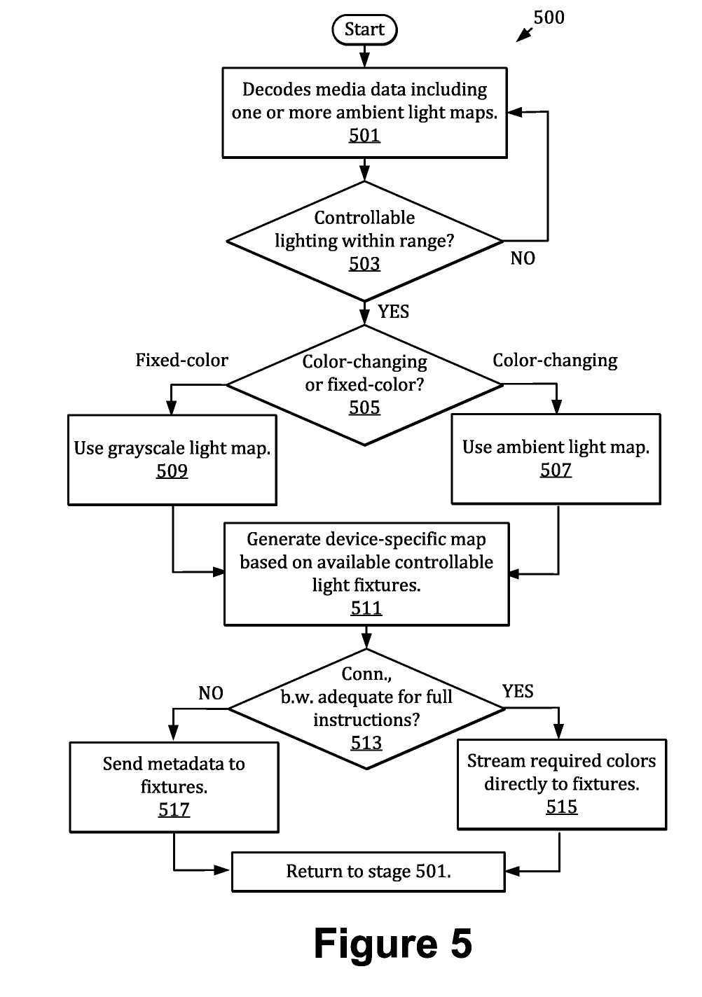

FIG. 5 shows a process 500 corresponding to steps taken upon receipt of media data including embedded ambient light maps. In the illustrated embodiment, the process 500 is executed at the portable device via the processor execution of computer-executable instructions read from a non-transitory computer-readable medium such as those discussed above with reference to FIG. 1. However, it will be appreciated that the execution of the illustrated steps may instead take place in total or in part at another device such as the stand alone display device.

At stage 501 of the process 500, the executing device receives and decodes media data including one or more ambient light maps. For example, the media data may have been packetized with a colored ambient light map and a grayscale ambient light map. The device then determines at stage 503 whether controllable lighting, e.g., one or more IoT fixtures, is within range of the device for transmitting instructions. If it is determined that there are no controllable light fixtures within range, the process 500 returns to stage 501.

Otherwise, the process flows to stage 505, wherein the device determines whether the in-range controllable lighting fixtures are color-changing or fixed-color. If it is determined that the in-range controllable lighting fixtures are color-changing, then the process 500 flows to stage 507, wherein the regular (colored) ambient light map is selected for use. If instead it is determined that the in-range controllable lighting fixtures are fixed-color, then the process 500 flows instead to stage 509, wherein the grayscale ambient light map is selected for use.

The process then flows from stage 507 or 509 to stage 511, wherein the processing device generates a device-specific map based on the available controllable light fixtures. However, specific instructions may or may not be sent to the available controllable light fixtures depending upon available connectivity and bandwidth.

At stage 513, the processing device determines whether the connectivity and bandwidth between the device and the controllable light fixtures is adequate for full instructions, and if so, the device streams the required colors directly to the fixtures at stage 515. If instead there is insufficient connectivity and bandwidth between the device and the controllable light fixtures for full instructions, the device may send out metadata instead at stage 517. From either of stages 515 and 517, the process 500 can return to stage 501 to await further media and maps.

Although the ambient light map has been discussed in keeping with various embodiments as including light intensity values and potentially also light color values, it will be appreciated that other sensory stimulants may be specified instead or in addition. For example, the ambient light map or an accompanying sense map may specify ambient temperature, ambient scent or ambient tactile stimulation such as vibration. Control of these sensory stimulants would be via connected appliances such as an IoT connected thermostat for temperature control, an IoT connected actuator for tactile stimulation control, and so on.

In an embodiment, the ambient light map values are generated based on the technical content of the media, that is, the computer-readable aspects of the media such as colors, aggregate intensity, spatial variations in light and so on. However, the ambient light map values may also be wholly or partly based on the substantive content of the media, such as mood, character arc (villain versus hero), and other non-computer-readable aspects of the media. In this case, the substantive content of the media may be identified by a person, such as someone associated with the media generation process.

It will be appreciated that various systems and processes for ambient lighting control through media have been disclosed herein. However, in view of the many possible embodiments to which the principles of the present disclosure may be applied, it should be recognized that the embodiments described herein with respect to the drawing figures are meant to be illustrative only and should not be taken as limiting the scope of the claims. Therefore, the techniques as described herein contemplate all such embodiments as may come within the scope of the following claims and equivalents thereof.

1. A method of transferring media content having an audio portion and a video portion comprising:
encoding the audio portion of the media content;
encoding the video portion of the media content;
generating a first ambient light map and a second ambient light map for controlling ambient lighting in synchrony with the media during playback of the media, the first ambient light map specifying light color and light intensity and the second ambient light map being a grayscale map specifying only light intensity; and
packaging the encoded audio portion, the encoded video portion and the ambient light maps in a transferrable package and transferring the package.

2. (canceled)

3. (canceled)

4. The method in accordance with claim 1, wherein generating the second ambient light map specifying only light intensity comprises generating the second map based on light color and light intensity values in the first map.

5. The method in accordance with claim 1, further comprising generating a temperature map for controlling ambient temperature in synchrony with the media during playback of the media, and wherein packaging further comprises packaging the temperature map in the transferrable package.

6. The method in accordance with claim 1, further comprising generating a sense map for controlling ambient sense stimulants in synchrony with the media during playback of the media, wherein the ambient sense stimulants include at least one of a scent stimulant and a tactile stimulant.

7. The method in accordance with claim 1, wherein the ambient light maps include one or more timestamps to synchronize values in the ambient light maps to points of time in the media during playback.

8. The method in accordance with claim 1, further comprising generating the ambient light maps based on a technical content of the media.

9. The method in accordance with claim 1, further comprising generating the ambient light maps based on a substantive content of the media.

10. A method of playing media content at a playback location comprising:
receiving a media content package, the media content package including an audio portion, a video portion and an ambient light map portion, wherein the ambient light map portion is time-synchronized with the audio portion and the video portion and includes a first part and a second part, wherein the first part specifies a light color and a light intensity and the second part is a grayscale ambient light map;
decoding the audio portion and the video portion of the media content package;
selecting one of the first part and the second part;
generating lighting instructions based on the selected part ambient light map; and
playing back the decoded audio and video portions while transmitting the lighting instructions to one or more ambient light fixtures at the playback location to control ambient lighting in synchrony with the played back audio and video portions.

11. The method in accordance with claim 10, further comprising determining a viewer mood, and wherein generating lighting instructions based on the selected part comprises generating lighting instructions based on both the selected part and the determined viewer mood.

12. The method in accordance with claim 11, wherein determining a viewer mood comprises predicting a viewer mood based on previously collected data from multiple users and refining the predicted viewer mood based on an analysis of image data of the viewer.

13. The method in accordance with claim 10, further comprising detecting a viewer position within the playback location, and wherein generating lighting instructions based on the selected part comprises generating lighting instructions based on both the selected part and the detected viewer position.

14. (canceled)

15. (canceled)

16. The method in accordance with claim 10, wherein the grayscale ambient light map is based on light color and light intensity values in the first part.

17. The method in accordance with claim 10, wherein the media content package further comprises a sense map for controlling ambient sense stimulants in synchrony with the media during playback of the media, wherein the ambient sense stimulants include at least one of a temperature, a scent and a tactile stimulant.

18. The method in accordance with claim 10, wherein the media content package further includes one or more timestamps to synchronize values in the first and second parts to points of time in the media during playback.

19. A method of controlling ambient lighting in a playback location comprising:
receiving media data and an ambient light map, the ambient light map specifying desired ambient lighting correlated with the received media data;
determining that one or more controllable ambient lighting fixtures is present in the playback location and determining that the one or more present controllable ambient lighting fixtures are controllable with respect to one of intensity alone and intensity and color;
modifying the ambient light map by converting any colored values into grayscale values if it is determined that the one or more present controllable ambient lighting fixtures are controllable with respect to intensity alone;
generating lighting instructions based on the ambient light map; and
transmitting the generated lighting instructions to the one or more present controllable ambient lighting fixtures.

20. The method in accordance with claim 19, further comprising detecting a viewer mood, and wherein modifying the ambient light map further comprises modifying the ambient light map based on the detected viewer mood.
